(19) United States
(12) Patent Application Publication
(10) Pub. No.: US 2017/0113948 A1
(43) Pub. Date: Apr. 27, 2017

(54) METHODS AND DEVICES COMPRISING SOLAR POWER FOR WATER PURIFICATION

(71) Applicant: Krithika Ramu Veerappan, Watchung, NJ (US)

(72) Inventor: Krithika Ramu Veerappan, Watchung, NJ (US)

(21) Appl. No.: 15/331,674

(22) Filed: Oct. 21, 2016

Related U.S. Application Data
(60) Provisional application No. 62/245,177, filed on Oct. 22, 2015.

(51) Int. Cl. C02F 1/14; C02F 1/68; B01D 1/00; B01D 5/00; C02F 1/28; C02F 1/00

(52) U.S. Cl. CPC C02F 1/14; C02F 1/283; C02F 1/001; B01D 1/0035; B01D 5/006; B01D 5/0072; B01D 5/009; C02F 1/68; C02F 2103/08

(57) ABSTRACT

The invention disclosed herein comprises novel methods and devices for water purification. The invention comprises the use of solar powered water purification units comprising, wherein said units may be portable, and comprise a vapor condensing unit, a water collection unit, a filter, a water inlet, and a vaporization unit. The water purification units comprise components for collecting solar energy, including but not limited to solar panels. The devices may optionally include an inflatable component enabling the device to be used on water as well as on solid surfaces.

### CROSS-REFERENCE TO RELATED PATENT APPLICATIONS

The present application claims priority to U.S. Provisional Patent Application Ser. No.: 62/245,177 filed on Oct. 22, 2015 and is incorporated herein by reference in its entirety.

### BACKGROUND

Solar energy is radiant light and heat from the sun that is harnessed using a range of ever-evolving technologies such as solar heating, photovoltaics, solar thermal energy, solar architecture and artificial photosynthesis. Solar energy is the cleanest and most abundant renewable energy source available, and in many parts of the world, solar energy has the potential to be the most conveniently and logically available source of energy. Modern technology can harness this energy for a variety of uses, including generating electricity, providing light or a comfortable interior environment, and heating water for domestic, commercial, or industrial use. There are several ways to harness solar energy: photovoltaics (also called solar electric), solar heating and cooling, concentrating solar power (typically built at utility-scale), and passive solar. The first three are active solar systems, which use mechanical or electrical devices that convert the sun's heat or light to another form of usable energy. Passive solar buildings are designed and oriented to collect, store, and distribute the heat energy from sunlight to maintain the comfort of the occupants without the use of moving parts or electronics. The term “solar panel” refers to a panel designed to absorb the sun's rays as a source of energy for generating electricity or heating. A photovoltaic system typically includes a panel or an array of solar modules, a solar inverter, and sometimes a battery and interconnection wiring.

Although 75% of the Earth is covered in water; the Earth's continents are like large islands in the planet's much more expansive oceans, access to clean, fresh drinking water is a major world concern. According to a recent study by Planet Green, 88% of deaths worldwide from diarrhea are caused from unsafe drinking water, inadequate availability of water for hygiene, and lack of access to sanitation; around 1.5 million children perish each year from unsafe water and inadequate sanitation. Furthermore, this amounts to 18% of all under-five deaths and means that more than 4,000 children are dying every day as a result of diarrheal diseases alone. The necessity for clean and usable water is a reality that pervades virtually every aspect of our existence, from agriculture to healthcare as well as the viability of Earth's ecosystems.

Water purification is the removal of contaminants from raw water to produce drinking water that is pure enough for human consumption or for industrial use. There are over twenty-five methods to purify water, divided into four categories: separation, filtration, chemicals, oxidation. Typically, at least five types of contaminants are found in water: particulates, bacteria, minerals, chemicals, and pharmaceuticals. Methods to remove these contaminants range from simple and inexpensive, to elaborate and costly. Often to achieve purely potable water, several technologies must be combined in a particular sequence. Discussed below are general descriptions of select methods currently employed to purify water.

Separation: Heat, Light & Gravity: sedimentation (gravitationally settles heavy suspended material); boiling (boiling water for 15 to 20 minutes kills 99.9% of all living things and vaporizes most chemicals, minerals, metals, solids and the contamination from the cooking container become more concentrated); distillation (boils and re-condenses the water, but many chemicals vaporize and re-condense in concentration in the output water. It is also expensive to boil and cool water); and ultraviolet light (good bactericide, but has no residual kill, and works only in clearly filtered water. Still in its infancy stage is a new technology involving super white light).

Chemicals: chlorine (is common, cheap, but extremely toxic; it does not decrease physical or chemical contamination, it does increase colesterol formations, is a carcinogen, and causes heart disease); bromine (used in pools and spas, doesn't smell or taste as bad and doesn't kill bacteria very well); iodine (not practical, is mostly used by campers); hydrogen peroxide (kills bacteria with oxygen, is chemically made and is very toxic; is used in emergencies); silver (an effective bactericide but a cumulative poison which concentrates and doesn't evaporate); nontoxic organic acids (should be used with caution in large water plants only); lime and milk alkaline agents (should also be used with caution only by large water plants, or only for laundry); neutralizing chemicals (adds chemicals which lump together suspended particles for filtration or separation); coagulation flocculation; ion exchange (exchanges sodium from salt for calcium or magnesium, using either glauconite (greensand), precipitated synthetic organic resins, or gel zeolite, thus softening the water. Minerals, metals, chemicals or odors are not affected, and the water is salty to drink).

Filtration: slow sand (1 cubic meter passes about 2 liters/min, and does a limited bacteria removal); pressure sand (1 cubic meter passes about 40 gpm and must be backwashed daily); diatomaceous earth (removes small suspended particles at high flow rates, must be daily backwashed and is expensive); porous stone/ceramic filters (filters are small but expensive, and do not effect chemicals, bacteria or odors); paper or cloth filters (filters are disposable and filter to one micron, but do not have much capacity); charcoal (compressed charcoal/carbon block is the best type of charcoal filter, can remove chemicals and lead, but is easily clogged, so should be used with a sediment prefilter; granular charcoal is cheaper, but water can flow around the granules without being treated; powdered charcoal is a very fine dust useful for spot cleaning larger bodies of water, but is messy and can pass through some filters and be consumed); reverse osmosis (uses a membrane with microscopic holes that require 4 to 8 times the volume of water processed to wash it in order to remove minerals and salt, but not necessarily chemicals and bacteria); enzymes and bacteria (combined can remove contaminants, reduce sludge, and even digest oil); and plants (numerous plants, animals and organisms that are quite effective in filtering water).

Oxidation: aeration (sprays water into the air to raise the oxygen content, to break down odors, and to balance the dissolved gases. However, it takes space, is expensive, and picks up contaminants from the air); ozone (is a very good bactericide, using highly charged oxygen molecules to kill microorganisms on contact, and to ozidize and flocculate iron, manganese and other dissolved minerals for post-filtration and backwashing) and electronic purification/dissolved oxygen generation (creates super oxygenated water in a dissolved state that lowers the surface tension of the water and effectively treats all three types of contamination: physical, chemical and biological).

As discussed above, gaining access to safe drinking water is a serious issue affecting people of all ages worldwide. For those living in remote communities where the availability of improved water sources is limited, challenges can be immense and impact quality of life in significant ways. According to the World Health Organization and United Nations Children Fund, more than one in six people—or 894 million—worldwide live in areas where the availability of safe water is limited. Poor water sanitation can leave adults and children susceptible to a variety of waterborne diseases, including typhus, cholera and typhoid fever. The risk of fatalities is so immense that every 20 seconds, a child passes away as a result of inadequate sanitation, according to the United Nations.

While a majority of the world is covered by water, only 2.5 percent of it is fresh. The rest is saline and ocean-based. Even then, just 1 percent of our freshwater is easily accessible, with much of it trapped in glaciers and snowfields. In essence, only 0.007 percent of the planet's water is available to fuel and feed its 6.8 billion people. Due to geography, climate, engineering, regulation, and competition for resources, some regions seem relatively flush with freshwater, while others face drought and debilitating pollution. In much of the developing world, clean water is either hard to come by or a commodity that requires laborious work or significant currency to obtain. According to the United Nations, water use has grown at more than twice the rate of population increase in the last century. By 2025, an estimated 1.8 billion people will live in areas plagued by water scarcity, with two-thirds of the world's population living in water-stressed regions as a result of use, growth, and climate change.

What is needed therefore, are effective, safe and affordable methods for purifying water and improving the quality of available water worldwide. Such methods should be easy to use and readily available for people in both industrialized and remote areas of the world.

### SUMMARY

Disclosed are novel methods and devices related to the use of solar power for generating clean water. As described herein, water is cleaned and/or purified in a mechanism powered by solar power (i.e. solar panels) such that the quality of water is suitable for consumption, including but not limited to, drinking water, cooking water, water for agricultural use, water for aquaculture and the like. The unique and novel device of the present invention is versatile, it may be portable, and it may be used in a variety of settings. In an embodiment, the device of the present invention is floatable and may be used on water surfaces as well as on hard surfaces. In an embodiment, the device is portable, foldable and easily transportable.

### BRIEF DESCRIPTION OF THE DRAWINGS

The accompanying drawings, which are incorporated in and constitute a part of this specification, illustrate several embodiments and together with the description illustrate the disclosed compositions and methods.

FIG. 1 provides a graphical image of the front open angular view of the water purification unit featuring the solar panel and parts of the other units.

FIG. 2 provides a graphical image of the open front view of the water purification unit featuring the solar panel.

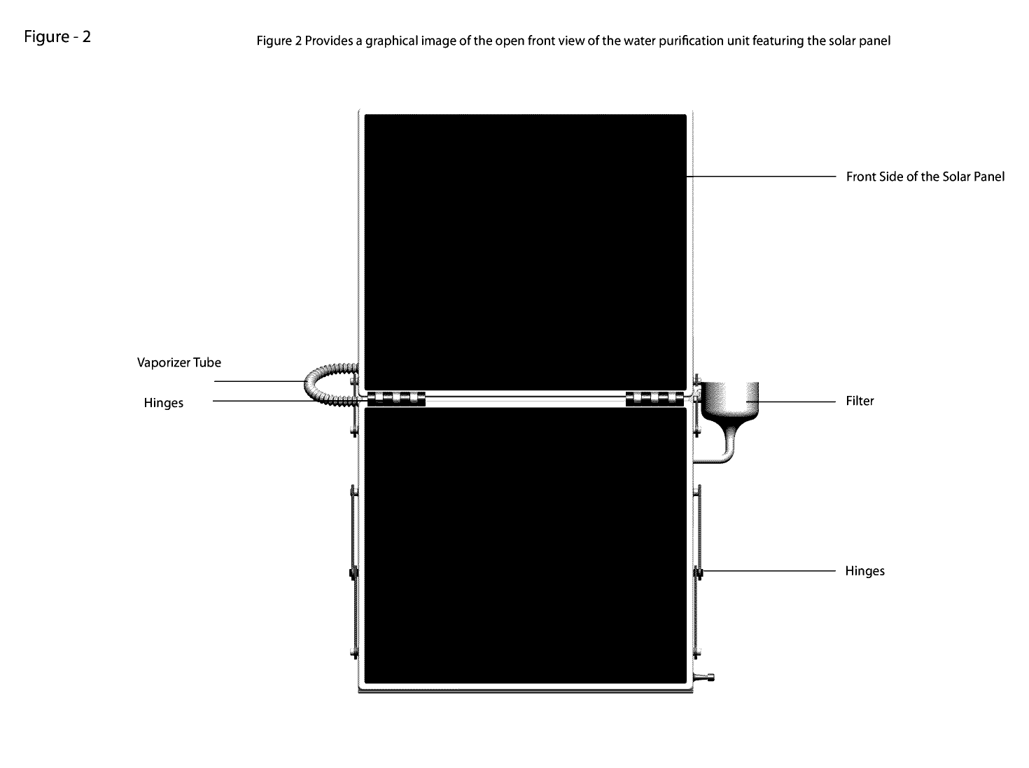

FIG. 3 provides a graphical image of the back side open angular view of the water purification unit featuring the vapor condensing and water collection unit and the backside of the solar panel.

FIG. 4 provides a graphical image of the open backview of the water purification unit featuring the vapor condensing and water collection unit and the backside of the solar panel.

FIG. 5 provides a graphical image of the side views of the water purification unit featuring the three main units of the system.

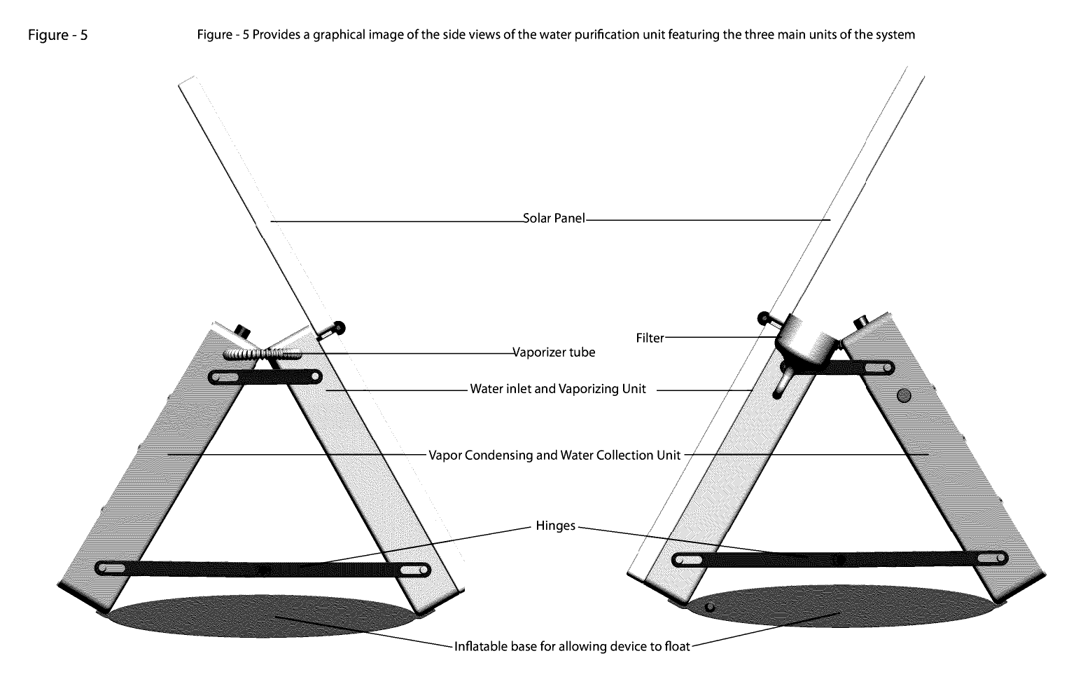

FIG. 6 provides a graphical image of the water inlet and vaporizing unit featuring the water collection area and vaporizer area.

FIG. 7 provides a graphical image of the front side closed angular view of the water purification unit featuring the folded solar panel and parts of other units.

FIG. 8 provides a graphical image of the closed front view of the water purification unit featuring the folded solar panel.

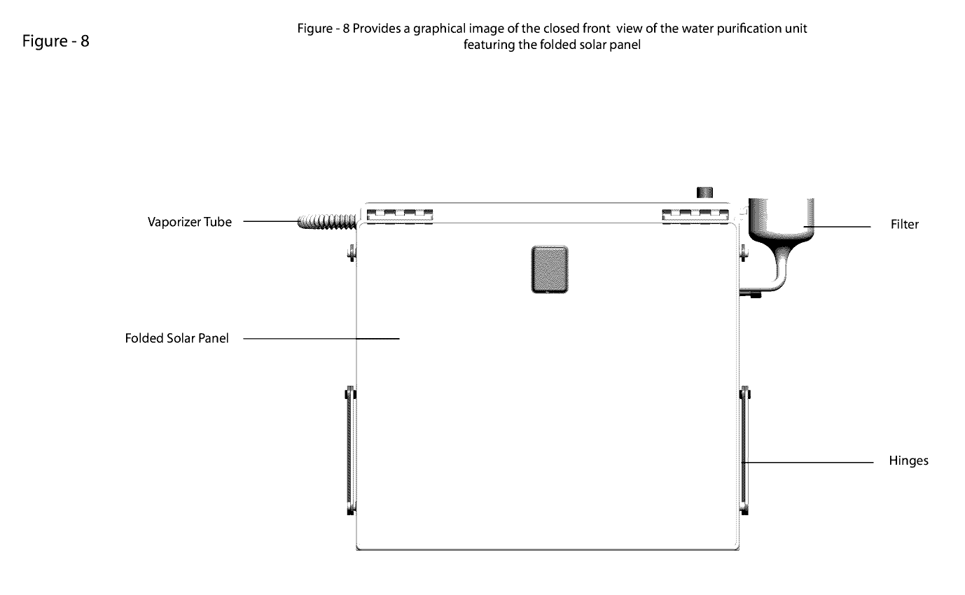

FIG. 9 provides a graphical image of the back side closed angular view of the water purification unit featuring the vapor condensing and water collection unit and the other units.

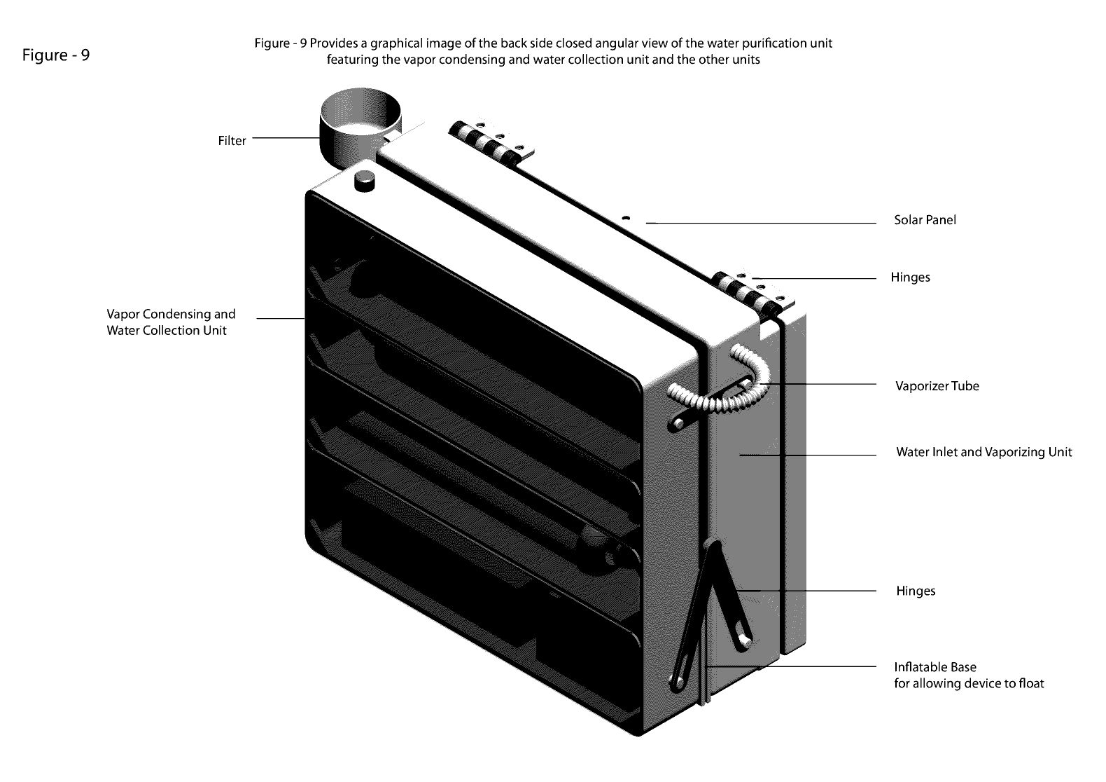

FIG. 10 provides a graphical image of the closed back view of the water purification unit featuring the vapor condensing and water collection unit.

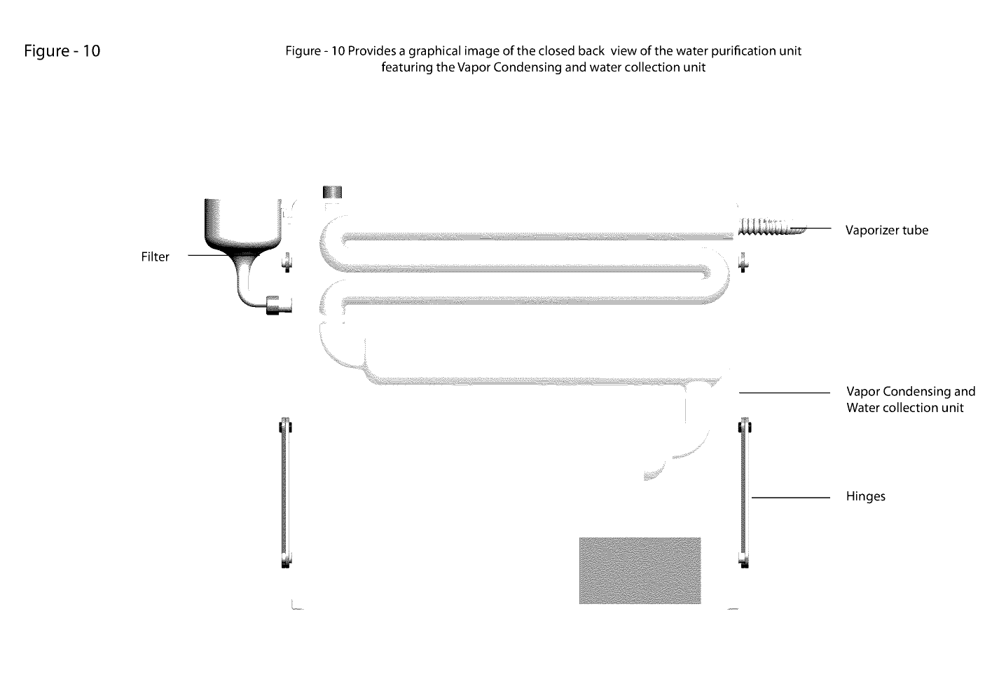

FIG. 11 Provides a graphical image of the side views of the water purification unit featuring the three main units of the system.

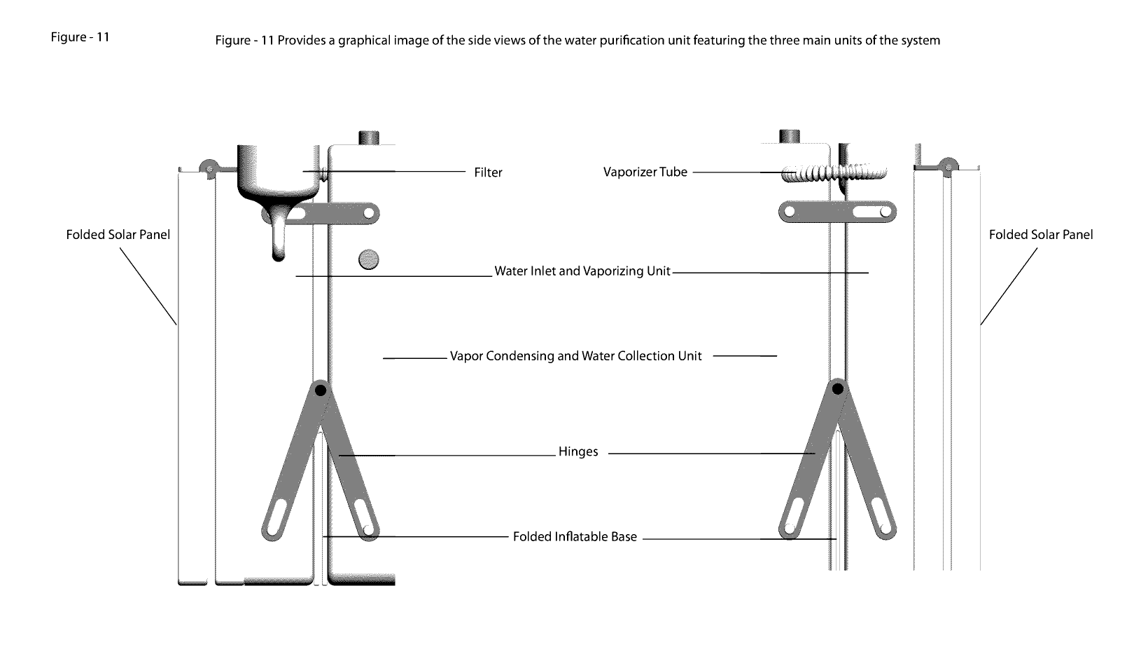

### DETAILED DESCRIPTION

Before the methods and/or devices, are disclosed and described, it is to be understood that they are not limited to specific methods or specific embodiments of the devices unless otherwise specified, or to particular components unless otherwise specified, as such may, of course, vary. It is also to be understood that the terminology used herein is for the purpose of describing particular embodiments only and is not intended to be limiting.

### Definitions

As used in the specification and the appended claims, the singular forms “a,” “an” and “the” include plural referents unless the context clearly dictates otherwise. Thus, for example, reference to “a solar panel” includes a variety of types and numbers of solar panels, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10”as well as “greater than or equal to 10” is also disclosed. It is also understood that throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

“Solar Panel” or “photovoltaics” are devices that convert solar energy into electric energy. A solar panel is generally a collection of solar cells. Lots of small solar cells spread over a large area provides enough power to be useful. As more light hits the cell more electricity is produced.

### Design

In an embodiment, the methods and devices of the present invention comprise certain major units: solar panel unit, water inlet and vaporization unit, water condensing and water collection unit, an optional unit for converting distilled water to drinking water, and an optional unit for enabling flotation. In certain embodiments, the device may be portable.

Solar Panel Unit: The Solar Panel Unit consists of one or more solar panels, either in foldable or regular format arranged in different shapes to collect solar power to heat the water. The solar panels connect to the heating surface and serve as the energy source to heat it. The heating surface may either heat or boil the water to accelerate the evaporation/condensation process. The solar panel derived energy (optionally along with the natural evaporation process) will increase the rate of the production of distilled water. An example of a commercially available solar panel unit that could be used for this invention is the 21W 2-Port USB Universal PowerPort Solar Charger (haps ://www.amazon.com/Brunton-Solaris-Foldable-Solar-Power/dp/B00J79SUJI). This type of foldable, multiple-panel unit can be flexible for the dimensions needed in the product. In the context of this invention, it is being used for charging purposes, but a similar structure and/or equivalent could be used for water heating as would be evident to one skilled in the art.

Water inlet and Vaporizer Unit: The Vaporizer unit may be in different shapes and different materials. In an example, unclean water can be held in pipes as depicted in the figures or in a square, rectangle, circular, other geometric shapes that fit the design of the device. Different materials may include, but are not limited to copper, stainless steel, aluminum, and iron. The main essence being that there is an area for unpurified water to be heated through the power collected from the solar panels. Unclean water is introduced to the vaporizer unit through the manual funnel filter which removes larger debris such as leaves. Inside the vaporizer unit along with the unclean water there is a heating coil which is heated by the energy derived from the solar panels. The unclean water is heated and the vapors rise up to the top of the vaporizer unit and leaves the unit through the vaporizer tube. Other technologies that enhance evaporation may also be used. Steel balls may be used in the heating chamber to clean the walls of the residue. This is simply a maintenance feature as steel balls are known to remove stains and can be used during cleaning of the unit.

Vapor Condensing and Water Collection Unit: The water vapor generated from the water inlet and vaporizer unit passes through the vaporizer tube and enters the cooling chamber. The cooling chamber comprises a tube enclosed in a water jacket. The purpose of the water jacket is to enhance the speed of condensation. The water vapor flows through this tube in the cooling chamber and condenses to purified water droplets. These droplets are passed through a carbon filter that removes chlorine, sediment, volatile organic compounds, taste and odor using the principles of chemical adsorption. The purified water that comes out from the carbon filter is collected in a collection chamber.

Converting Distilled Water to Drinking Water (optional): In the collection chamber necessary minerals and nutrients are optionally added to the purified/distilled water. Such minerals may include desired quantities of iron, zinc, copper, iodine, calcium, phosphorus, magnesium, fluoride, sodium, potassium, and/or chloride. These are the minerals and nutrients that are typically included in drinking water but that are not found in distilled water. In an embodiment, these minerals and nutrients may be added through allowing the water collected in the collection chamber to flow through a porous layer of minerals and nutrients. A variation may include a dosing mechanism for mixing in mineral capsules to a measured amount of water. A variation may also include adding the mineral capsules manually to a measured amount of water. Such variations and modifications would be evident to one skilled in the art.

Floating Mechanism (optional): A floating mechanism, wherein an inflatable or floating part is added to the invention to allow the water purification process to take place in water filled areas such as a lake, river, ocean or flooded areas. This floating mechanism can be in any shape or size. The inflatable component may be attached in between the water inlet and vaporizing unit and vapor condensing and water collection unit. When the unit is used on land the inflatable remains uninflated. When the unit is to be used on water then the inflatable component is inflated so the unit can float and function on the water surface. One example of an inflatable unit may be a rubberized bladder that can be filled with air by conventional means such as by mouth or by using a pump.

Process: Electrical energy collected from the solar panel is connected to the heating coil in the vaporizer unit. When the heating coil is energized, the water temperature will be increased and the water starts vaporizing. When the vapor reaches the condensing unit the vapor is cooled and converts to water drops. The water drops then pass through the charcoal unit and get collected in a chamber where the minerals are added. The output will result in drinking water.

The above features may be enhanced or changed to make the invention more efficient, less bulky, better for packaging or any other purpose. For instance, materials that enhance or improve the product may also be added, such as reflective materials to increase the intensity of the sun, thus making the distillation process more efficient. The invention may be used to address emergency water-related situations, situations that call for distilled or potable water, or any other situations or purposes.

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### EXAMPLE

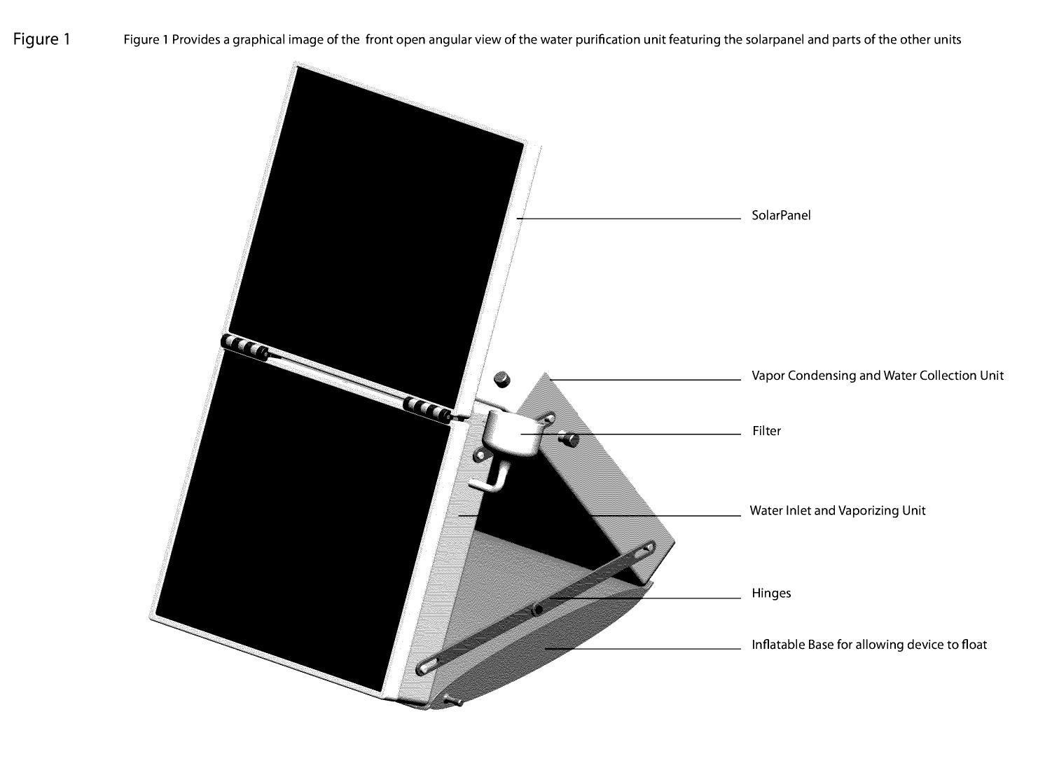

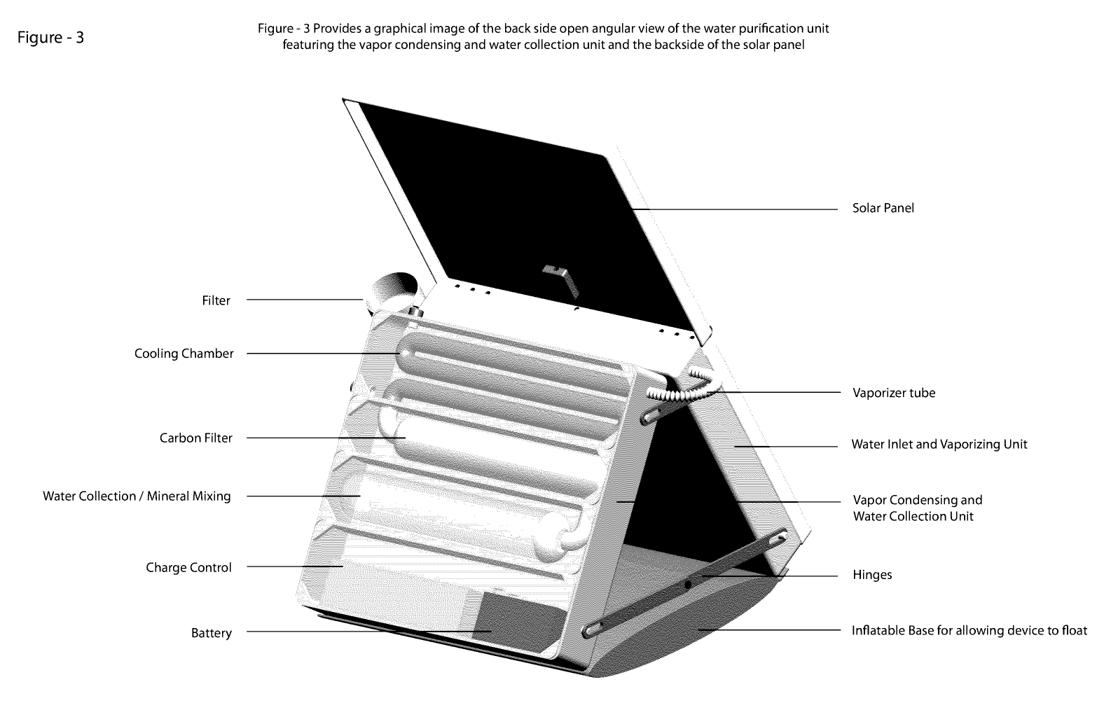

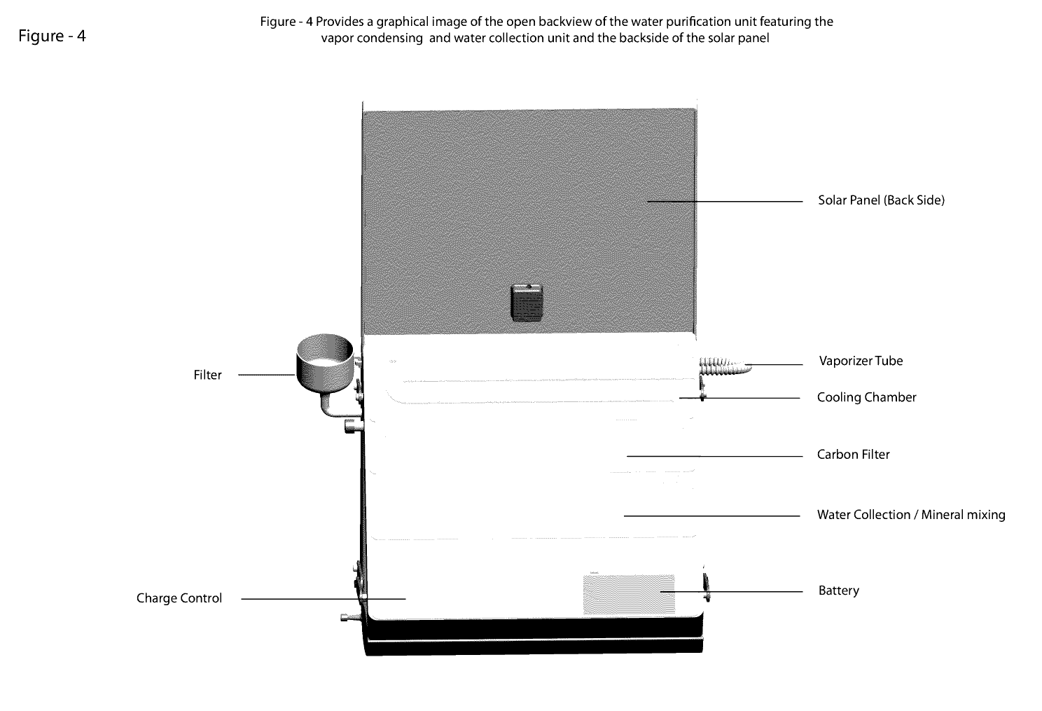

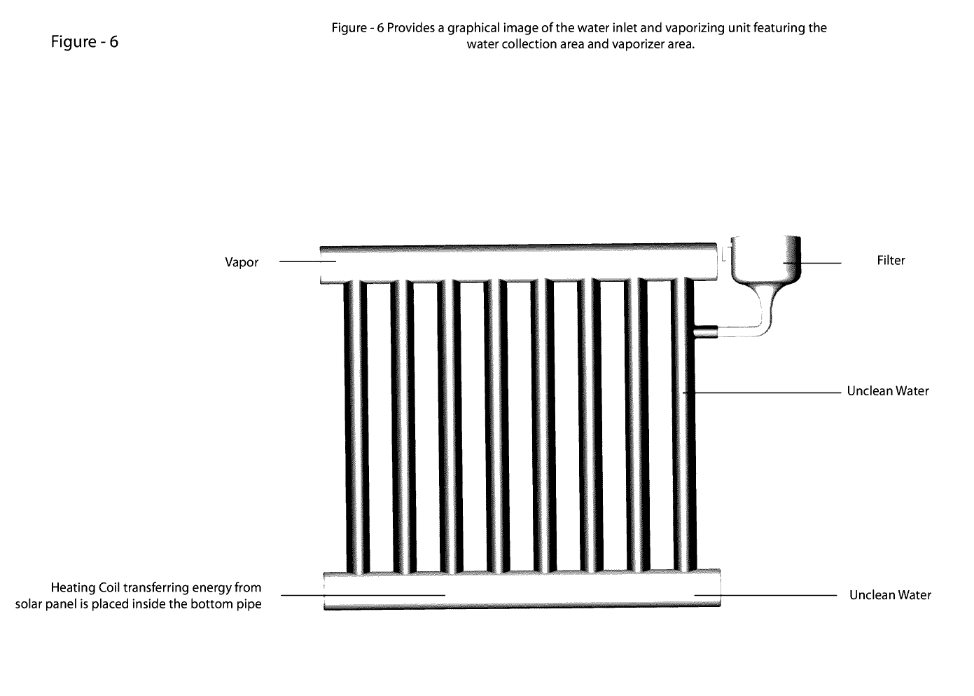

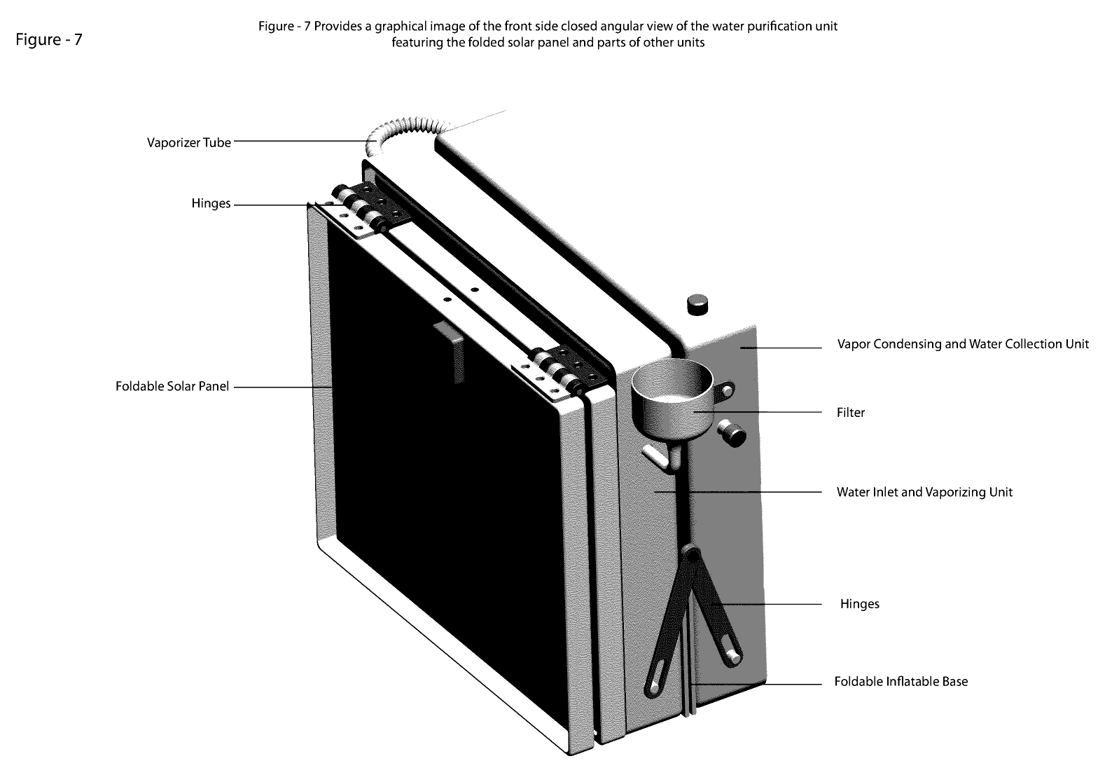

The closed water purification unit (See FIG. 7) is opened and set up on a flat surface on land as in FIG. 1. For use on a water surface, the inflatable base is filled with air. The device is kept out during the daytime so solar power is collected. When ready to use, unclean/salt water is poured into the device of the present invention at the filter (cup) as seen in FIG. 1. The power on the battery (See FIG. 4) in the vapor condensation and water collection unit is turned on. This starts heating the heating coil (See FIG. 6) which in turn heats the unclean water in the same area which was poured through the filter. The heated water starts converting to steam/vapor and rises to the top (See FIG. 6). The vapor leaves the water collection and vaporization unit through the vaporizer tube (See FIG. 3) and enters the cooling chamber where it is converted to water droplets. These droplets then pass through the carbon filter and get collected in the water collection unit as purified distilled water. It may now pass through a mechanism where minerals and nutrients are mixed and the process gets completed with the output of purified drinking water.

What is claimed is:

1. A solar powered water purification unit comprising a portable unit having a vapor condensing unit, a water collection unit, a filter, a water inlet, and a vaporization unit.

2. The unit of claim 1, wherein the unit comprises solar panels.

3. The unit of claim 2, wherein the solar panels are consecutively arranged to cover the surface of the unit.

4. The unit of claim 3, wherein the solar panels are arranged in a mosaic pattern to facilitate folding of the unit.

5. The unit of claim 1, wherein the unit further comprises an inflatable component.

6. The unit of claim 1, wherein water is collected in a filter cup, and wherein the water then flows through a vaporizer tube, through a cooling chamber, through a carbon filter and to a water collection area.

7. The unit of claim 1, wherein the water collection area further comprises minerals.

8. The unit of claim 1, wherein the minerals comprise iron, zinc, copper, iodine, calcium, phosphorus, magnesium, fluoride, sodium, potassium, and chloride.

9. A method for purifying water comprising the use of a solar powered water purification unit, wherein the unit comprises a portable unit having a vapor condensing unit, a water collection unit, a filter, a water inlet, and a vaporization unit.

10. The method of claim 9, wherein the unit comprises solar panels.

11. The method of claim 10, wherein the solar panels are consecutively arranged to cover the surface of the unit.

12. The method of claim 10, wherein the solar panels are arranged in a mosaic pattern to facilitate folding of the unit.

13. The method of claim 9, wherein the unit further comprises an inflatable component.

14. The method of claim 9, wherein water is collected in a filter cup, and wherein the water then flows through a vaporizer tube, through a cooling chamber, through a carbon filter and to a water collection area.

15. The method of claim 9, wherein the water collection area further comprises minerals.

16. The method of claim 15, wherein the minerals comprise iron, zinc, copper, iodine, calcium, phosphorus, magnesium, fluoride, sodium, potassium, and chloride.
